(19) United States
(12) Patent Application Publication
(10) Pub. No.: US 2026/0165435 A1
(43) Pub. Date: Jun. 18, 2026

(54) Quick Bag

(71) Applicant: New Century Products Co., Ltd., Taipei City (TW)

(72) Inventor: Fu-Tsun Lin, Taipei City (TW)

(21) Appl. No.: 18/986,047

(22) Filed: Dec. 18, 2024

(51) Int. Cl. A45C 3/00; A01K 1/02; A01K 1/035; A45C 13/10; A45C 13/12; A47C 29/00

(52) U.S. Cl. CPC A45C 3/001; A01K 1/0254; A01K 1/029; A01K 1/0353; A45C 13/103; A45C 13/12; A45C 2003/002; A45C 2013/1015; A47C 29/006

(57) ABSTRACT

The present invention discloses a quick bag, including: a bottom plate, a bending portion being arranged in the middle of the bottom plate; a front plate, connected to a side edge of the bottom plate, a front bending portion being provided at a position where the front plate is connected to the bottom plate; a back plate, connected to a side edge of the bottom plate, the back plate and the front plate being disposed in parallel on two opposite sides of the bottom plate, respectively, and a back bending portion being provided at a position where the back plate is connected to the bottom plate; two elastomers, each of the elastomers being provided on two side edges of the front plate and the back plate, respectively; and a wrapping layer, wrapping the bottom plate, the front plate, the back plate and each of the elastomers, each of the elastomers driving the front plate and the back plate through the wrapping layer to be unfolded or folded. During unfolding, the bottom plate, the front plate, the back plate and each of the elastomers form a storage space. The quick bag of the present invention provides the function of quick unfolding or quick folding, which is convenient for users to carry and store

### BACKGROUND OF THE INVENTION

### 1. Field of the Invention

The present invention relates to a handbag, and particularly to a quick bag capable of being quickly unfolded, quickly folded and conveniently carried.

### 2. Description of the Prior Art

A pet backpack is the best choice for traveling with pets. There is an existing pet backpack. A wide variety of pet backpacks are available, offering breathable comfort, convenience of carrying or wide space. However, if there are both young children and pets in the family, requirements for choosing a pet backpack will be more stringent.

In overview, existing pet backpacks have the disadvantages listed below:
1. Insufficient space: the interior space of the pet backpack is narrow, so the pet cannot rest or turn around comfortably, and prolonged standing position or sitting position leads to great discomfort.
2. Ventilation problem: the biggest and most easily overlooked drawback of an ordinary pet backpack is insufficient ventilation, which may lead to the risk of excessive internal temperature or oxygen deprivation, posing a threat to the health of pets.
3. Insufficient stationarity: excessive swaying of the owner's body or struggling of the pet in the ride during walking causes the pet backpack to be in an unstable state, resulting in injuries caused by the pet hitting or the owner falling.
4. Structural safety problem: a plastic window or zipper may be broken, which results in damage, leading to the risk of pets falling or escaping.

There is also a top-opening cage-like pet backpack in the market, the biggest advantage of which is the convenience of carrying pets, the biggest disadvantage of the top-opening cage is the heavier weight, and the weight of pets will cause excessive burden on arms of the user when he/she carries the top-opening cage by hand, so the top-opening cage-like pet backpack is not practical.

Moreover, the top-opening cage has another disadvantage that the top-opening cage is too heavy to carry when the pet is carried outside. When placed indoors, the top-opening cage has large volume and occupies more space.

As mentioned above, in view of the shortcomings of the customary knowledge, the creator was eager to improve and innovate, and after many years of painstaking research, finally succeeded in developing and completing the quick bag of the present invention.

### SUMMARY OF THE INVENTION

A main objective of the present invention is to provide a quick bag, which can be quickly unfolded and quickly folded, and is convenient for a user to store and manage and convenient for the user to carry after folding.

To achieve the above objective, the present invention provides a quick bag, including: a bottom plate, a bending portion being arranged in the middle of the bottom plate, and the bottom plate being folded through the bending portion; a front plate, connected to a side edge of the bottom plate, a front bending portion being provided at a position where the front plate is connected to the bottom plate; a back plate, connected to a side edge of the bottom plate, the back plate and the front plate being disposed in parallel on two opposite sides of the bottom plate, respectively, and a back bending portion being provided at a position where the back plate is connected to the bottom plate; two elastomers, each of the elastomers being provided on two side edges of the front plate and the back plate, respectively; and a wrapping layer, wrapping the bottom plate, the front plate, the back plate and each of the elastomers, and enabling each of the elastomers to drive the front plate and the back plate through the wrapping layer to be unfolded or folded, and during unfolding, the bottom plate, the front plate, the back plate and each of the elastomers forming a storage space.

A male hook-and-loop tape is disposed on a side of the two opposite sides of the bottom plate near the front plate, a female hook-and-loop tape is disposed on a side of the two opposite sides of the bottom plate near the back plate, and the male hook-and-loop tape and the female hook-and-loop tape are used for the quick bag to be fixed after folding.

The wrapping layer includes a mesh fabric, and the mesh fabric is connected among the front plate, the back plate and the bottom plate.

The wrapping layer includes at least one pocket provided outside the wrapping layer relative to the storage space, to provide a user with a place to place items.

At least one side fixing plate is provided within the wrapping layer, and the side fixing plate supports the elastomers and improves the structural strength of the unfolded quick bag.

The front plate further includes a side pocket provided outside the front plate relative to the storage space, to provide the user with a place to place items, the side pocket is a closed type, and the closed fixation mode adopts one of a button, a touch fastener and a zipper.

The quick bag further includes a bed net, and the bed net is provided inside the side pocket.

The back plate further includes a side opening formed in an outside of the back plate relative to the storage space, and the side opening is closed by one of a button, a touch fastener, a latch, a zipper and a grommet.

The quick bag further includes a fleece cover that is removably wrapped around the quick bag. In summary, during use, the quick bag of the present invention can be quickly unfolded and shaped by utilizing the elasticity of the elastomers. When the quick bag is folded, as long as the elastomers are bent towards the storage space, the front plate and the back plate are bent towards the storage space, and the male hook-and-loop tape is fixed to the female hook-and-loop tape, so that quick folding can be achieved.

### BRIEF DESCRIPTION OF THE DRAWINGS

FIG. 1 is a three-dimensional schematic diagram of a first embodiment of a quick bag of the present invention;

FIG. 2 is a schematic diagram of a first step of folding the quick bag of the present invention;

FIG. 3 is a schematic diagram of a second step of folding the quick bag of the present invention;

FIG. 4 is a schematic diagram of a third step of folding the quick bag of the present invention;

FIG. 5 is a three-dimensional schematic diagram of a second embodiment of a quick bag of the present invention; and

FIG. 6 is a three-dimensional schematic diagram of a third embodiment of a quick bag of the present invention.

### DESCRIPTION OF REFERENCE NUMERALS

10: quick bag
11: strap
20. front plate
201: front bending portion
21: back plate
211: back bending portion
22: male hook-and-loop tape
23: female hook-and-loop tape
24: side pocket
25: side opening
26: carrying handle
30: bottom plate
301: bending portion
40: elastomer
50: wrapping layer
51: mesh fabric
52: pocket
53: side fixing plate
60: storage space
70: bed net

### Detailed Description of the Preferred Embodiment

To facilitate understanding of the examination committee for the technical features, contents and advantages of the present invention and the effects achieved thereby, the present invention will be described in details with reference to the accompanying drawings and attachments by means of the embodiments. The drawings used therein are only intended to illustrate and assist the specification, and may not be the true scale and precise configuration of the present invention after implementation. Therefore, the scale and configuration relationship of the accompanying drawings should not be interpreted to limit the application scope.

In the description of embodiments of the present invention, it is to be understood that terms “length”, “width”, “upper”, “lower”, “front”, “back”, “left”, “right”, “vertical”, “horizontal”, “top”, “bottom”, “inside”, “outside” and the like indicate orientations or positional relationships based on those shown in the drawings, and are intended only to facilitate the description of embodiments of the present invention and to simplify the description, rather than to indicate or imply that devices or elements referred to must have a particular orientation, be constructed and operated with a particular orientation, and therefore cannot be construed as a limitation of the present invention.

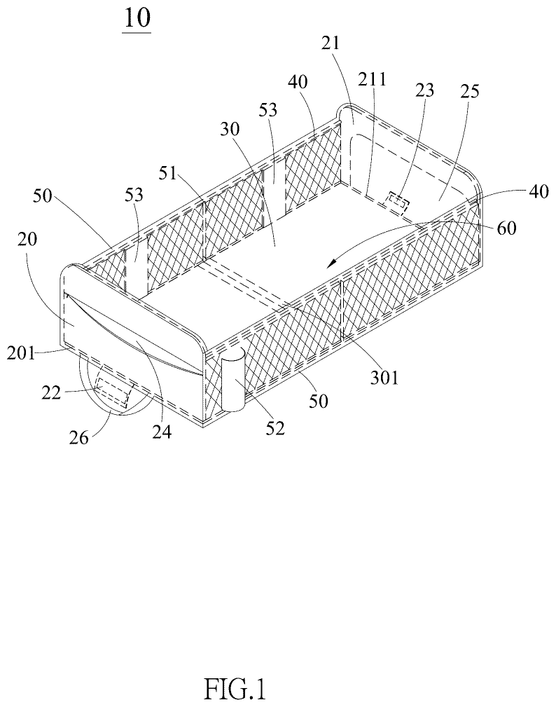

Referring to FIG. 1, it is a three-dimensional schematic diagram of a first embodiment of a quick bag 10 of the present invention. The quick bag includes: a front plate 20, a back plate 21, a bottom plate 30, two elastomers 40 and a wrapping layer 50.

A bending portion 301 is arranged in the middle of the bottom plate 30. When the quick bag 10 is folded, the bottom plate 30 is folded in half along the bending portion; and when the quick bag 10 is unfolded, the bottom plate 30 provides the function of bearing items, children or pets. The front plate 20 is connected to a left edge of the bottom plate 30, and a front bending portion 201 is provided at a position where the front plate 20 is connected to the bottom plate 30. When the quick bag 10 is unfolded or folded, the front plate 20 is bent along the front bending portion 201 towards the bottom plate 30.

The back plate 21 is connected to a right edge of the bottom plate 30, the back plate 21 and the front plate 20 are disposed in parallel on two opposite sides of the bottom plate 30, respectively, and a back bending portion 211 is provided at a position where the back plate 21 is connected to the bottom plate 30. When the quick bag 10 is unfolded or folded, the back plate 21 is bent along the back bending portion 211 towards the bottom plate 30.

The elastomers 40 are disposed between the front plate 20 and the back plate 21, and each of the elastomers 40 is disposed on a left side and a right side of the front plate 20 and the back plate 21, respectively. When the quick bag 10 is folded, the elastomers 40 can be curled and folded into the quick bag 10, and when the quick bag 10 is unfolded, the elastomers 40 can be quickly stretched to the original length, reducing the time for unfolding the quick bag 10.

The bottom plate 30, the front plate 20, the back plate 21 and each of the elastomers 40 are wrapped by the wrapping layer 50. When the quick bag 10 is unfolded or folded, the front plate 20 and the back plate 21 are driven by each of the elastomers 40 through the wrapping layer 50 to be unfolded or folded. When the quick bag 10 is unfolded, the bottom plate 30, the front plate 20, the back plate 21 and each of the elastomers 40 form a storage space 60.

A male hook-and-loop tape 22 is disposed on a side of the two opposite sides of the bottom plate 30 near the front plate 20, a female hook-and-loop tape 23 is disposed on a side of the two opposite sides of the bottom plate 30 near the back plate 21, and the male hook-and-loop tape 22 and the female hook-and-loop tape 23 are used for the quick bag 10 to be fixed after folding. The fixing mode may be one of a button, a touch fastener, a latch, a zipper and a grommet.

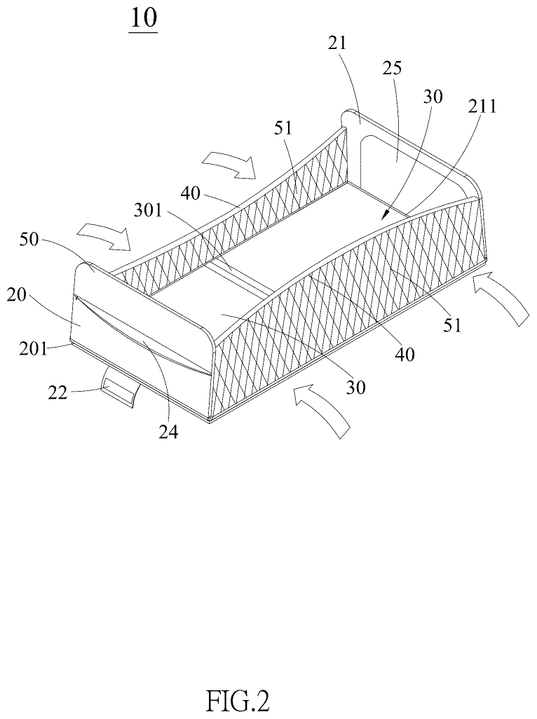

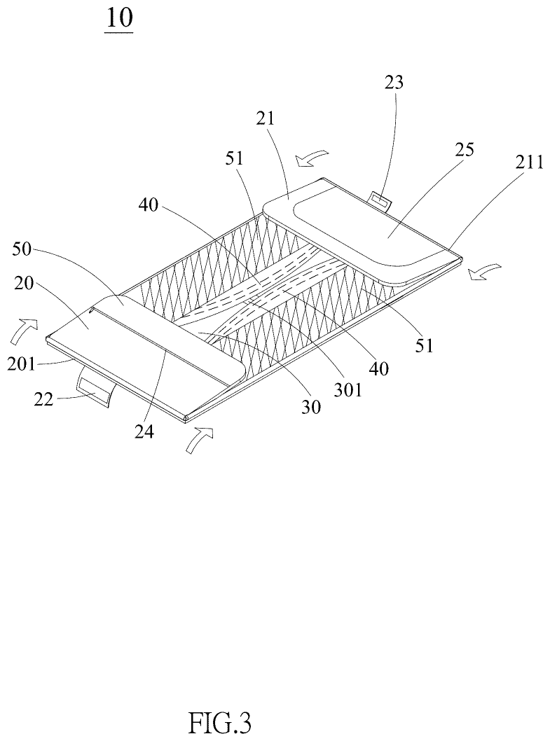

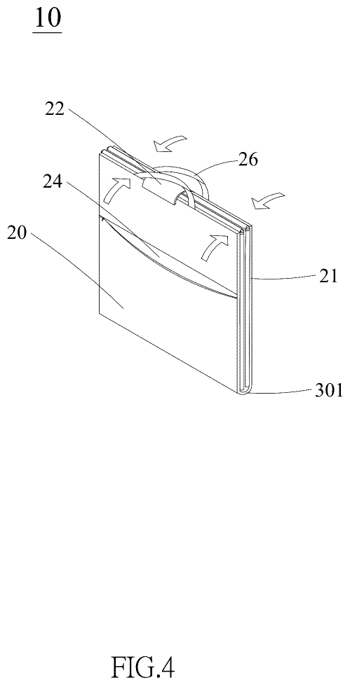

Referring to FIG. 2 to FIG. 4, they are schematic diagrams of steps of folding the quick bag of the present invention. The steps of folding the quick bag 10 are:
1. two elastomers 40 are bent inwardly, respectively, the front plate 20 is driven by the elastomers 40 to be bent onto the bottom plate 30 through the front bending portion 201, and the back plate 21 is driven by the elastomers 40 to be bent onto the bottom plate 30 through the back bending portion 211, so that the front plate 20 and the back plate 21 are overlaid on the bottom plate 30;
2. the bottom plate 30 is folded in half along the bending portion 301 and the front plate 20 is overlapped with the back plate 21; and
3. the male hook-and-loop tape 22 located on the front plate 20 is attached to the female hook-and-loop tape 23 located on the back plate 21 to attach and fix the front plate 20 to the back plate 21, that is, to complete the folding action.

Referring again to FIG. 1, the wrapping layer 50 includes a mesh fabric 51 and a pocket 52, and the mesh fabric 51 is connected among the front plate 20, the back plate 21 and the bottom plate 30; the pocket 52 is provided outside the wrapping layer 50 relative to the storage space 60, to provide the user with the ability to place items into the pocket 52 after unfolding the quick bag 10.

The wrapping layer 50 includes at least one side fixing plate 53. In this embodiment, illustrated by four side fixing plates, each of the side fixing plates 53 is provided inside the wrapping layer 50 to improve the structural strength of the quick bag 10.

The front plate 20 further includes a side pocket 24 provided outside the storage space 60, the side pocket 24 may be a closed type or open type, and the side pocket 24 may be closed by one of a button, a touch fastener, and a zipper. The side pocket 23 provides a larger storage space for the quick bag 10.

The front plate 20 and the back plate 21 further include two carrying handles 26, disposed on the front plate 20 and the back plate 21 near the edge of the bottom plate 30, to provide the user with the convenience of carrying the quick bag 10 after being folded.

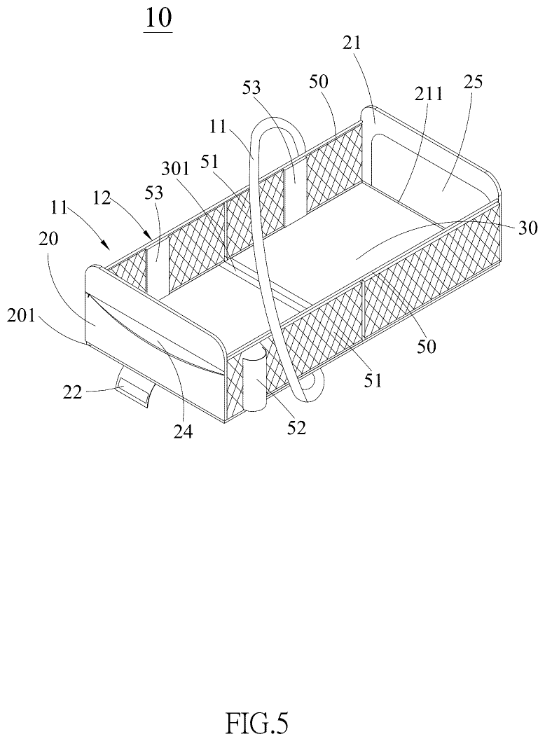

Referring to FIG. 5, it is a three-dimensional schematic diagram of a second embodiment of a quick bag of the present invention. In another embodiment, the quick bag 10 includes a strap 11, both ends of the strap 11 are fixed around the quick bag 10 outside the storage space 50, and the strap 11 provides the user with the convenience of carrying the folded quick bag 10. The fixing mode may be one of a button, a touch fastener, a latch, a zipper and a grommet.

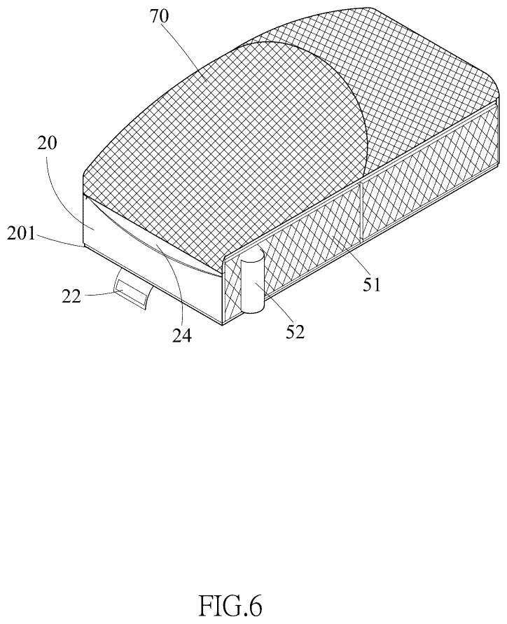

Referring to FIG. 6, it is a three-dimensional schematic diagram of a third embodiment of a quick bag of the present invention. The quick bag 10 further includes a bed net 70 provided inside the side pocket 24, and the steps of using the bed net 70 are as follows:
1. the bed net 70 is withdrawn from the side pocket 24;
2. the bed net 70 is fixed to the mesh fabric 51 on both sides, where the fixing mode may be fixed by one of a button, a touch fastener, a latch, a zipper and a grommet; and
3. finally, the bed net 70 is wrapped around the front plate 20, where since one side of the bed net 70 is connected to the back plate 21, the bed net 70 will be completely wrapped directly over the storage space 60, so that pets or children located inside the bed net 70 can be protected from mosquito bites.

The front plate 20, the back plate 21 and the side fixing plates 53 are made of a malleable material, thereby improving the structural strength of the quick bag 10 and ensuring that the pets or children are prevented from being injured when colliding with the front plate 20, the back plate 21 and the side fixing plates 53. The malleable material is for example: plastic, rubber or PSM.

A soft cushion is further included in the storage space 60, and the soft cushion is laid on the bottom plate 30. The content of the cushion is sponge, providing a softer and more comfortable cushion for pets or children in the ride.

In an embodiment, the quick bag 10 of the present invention further includes a fleece cover (not shown in the figures), which is unfolded and sleeved from the top to the bottom along the periphery of the quick bag 10 to completely wrap the quick bag 10 and increase the comfort of pets during use.

Referring again to FIG. 1, in the first embodiment, the back plate 21 includes a side opening 25 penetrating through the back plate 21. When the bed net 70 covers the unfolded quick bag 10, the side opening 25 can be pulled open if children or pets need a larger space to move around, so that the unfolded quick bag 10 has a broader space to move around.

The above-mentioned embodiments express only some of the embodiments of the present invention but are not intended to limit the patent scope of the present invention, and for those of ordinary skill in the art, a number of variations and improvements derived therefrom without departing from the technical features constructed by the patent scope of the present invention all fall within the scope of protection of the present invention.

1. A quick bag, comprising:
a bottom plate, a bending portion being arranged in the middle of the bottom plate, and the bottom plate being folded through the bending portion;
a front plate, connected to a side edge of the bottom plate, a front bending portion being provided at a position where the front plate is connected to the bottom plate;
a back plate, connected to a side edge of the bottom plate, the back plate and the front plate being disposed in parallel on two opposite sides of the bottom plate, respectively, and a back bending portion being provided at a position where the back plate is connected to the bottom plate;
two elastic members, each of the elastic members being provided on two side edges of the front plate and the back plate, respectively connecting the front plate and the back plate; and
a wrapping layer, comprising a mesh fabric, the mesh fabric being connected among the front plate, the back plate and the bottom plate, each of the elastic members wrapped by the wrapping layer, and driving the front plate and the back plate through the wrapping layer to be unfolded or folded, and during unfolding, the bottom plate, the front plate, the back plate and each of the elastic members forming a storage space.

2. The quick bag according to claim 1, wherein a male hook-and-loop tape is disposed on a side of the two opposite sides of the bottom plate near the front plate, a female hook-and-loop tape is disposed on a side of the two opposite sides of the bottom plate near the back plate, and the male hook-and-loop tape and the female hook-and-loop tape are used for the quick bag to be fixed after folding.

3. (canceled)

4. The quick bag according to claim 1, wherein the wrapping layer comprises at least one pocket provided outside the wrapping layer relative to the storage space, to provide a user with a place to place items.

5. The quick bag according to claim 1, wherein at least one side fixing plate is provided within the wrapping layer, and the side fixing plate supports the elastic members and improves the structural strength of the unfolded quick bag.

6. The quick bag according to claim 1, wherein the front plate further comprises a side pocket provided outside the front plate relative to the storage space, to provide the user with a place to place items.

7. The quick bag according to claim 5, wherein the side pocket is a closed type, and the closed fixing mode adopts one of a button, a touch fastener and a zipper.

8. The quick bag according to claim 5, wherein the quick bag further comprises a bed net, and the bed net being provided in the side pocket.

9. The quick bag according to claim 1, wherein the back plate further comprises a side opening provided outside the back plate relative to the storage space.

10. The quick bag according to claim 1, wherein the quick bag further comprises a fleece cover that is removably wrapped around the quick bag.
